(19) United States
(12) Patent Application Publication
(10) Pub. No.: US 2025/0171293 A1
(43) Pub. Date: May 29, 2025

(54) Multi-Directional Tap Handle for Beverage Dispensing Systems

(71) Applicant: Carlsberg Breweries A/S, Copenhagen V (DK)

(72) Inventor: Klaus Laybourn, Copenhagen V (DK)

(73) Assignee: Carlsberg Breweries A/S, Copenhagen V (DK)

(21) Appl. No.: 18/839,772

(22) PCT Filed: Feb. 24, 2023
(86) PCT No.: PCT/EP2023/054636

§ 371 Date: Aug. 20, 2024

(30) Foreign Application Priority Data
Feb. 25, 2022 (EP) 22158827.0

(51) Int. Cl. B67D 1/14

(52) U.S. Cl. CPC B67D 1/1477

(57) ABSTRACT

A beverage font assembly includes a tapping head with a tap handle and a valve arranged in the tapping head to control the flow of beverage from a dispensing line. The tap handle is configured to open the valve by being tilted from a non-dispensing position in at least two distinct non-opposing directions to assume a dispensing position. The tap handle may be rotatable in the non-dispensing position about a longitudinal axis relative to the tapping head. The dispensing of the beverage may be limited to certain operating angles wherein the tap handle is tiltable; and non-operating angles located in between the operating angles wherein the tap handle is non-tiltable.

### TECHNICAL FIELD

The disclosure relates to a beverage dispensing system for dispensing a beverage, and more particularly to a beverage font assembly with a tap handle for dispensing a beverage stored in a beverage container from multiple directions.

### BACKGROUND

Conventional beverage dispensing systems intended for professional or private use such as the DraughtMaster® system produced by the applicant company are described in e.g., WO 2007/019848, WO 2007/019849, WO 2007/019850, WO 2007/019851 and WO 2007/019853.

Beverage dispensing systems are typically used in beverage dispensing establishments for efficiently dispensing large quantities of beverage, including carbonated alcoholic beverages such as draught beer and cider, non-alcoholic beverages such as soft drinks and non-carbonated beverages such as wine and fruit juice. Beverage dispensing systems are mostly used by professional users in establishments like bars, restaurants and hotels, however, increasingly by private users in private homes.

Some beverage dispensing systems, such as the above mentioned DraughtMaster™ system, use a lightweight, collapsible and disposable beverage container or keg for accommodating the beverage and a pressurizing system for allowing the beverage flow from the beverage container to a tapping system, such as a tapping head. The collapsible beverage container is typically made of thin and flexible plastic material and may even be in the form of a plastic bag. Such beverage dispensing systems using collapsible beverage kegs can have the beverage keg installed or placed in a pressure chamber.

For performing a dispensing operation, a tap handle is typically tilted in the direction of an operator, such as a bartender or barmaid, which causes pressure to be released into the pressure chamber. The pressure applied causes the beverage to flow out of the beverage keg and into a dispensing line, which leads to the tapping head. The tap handle is usually linked to a tapping valve and thereby controls the beverage dispensing operation. Typically, the tap handle is a part of a beverage font mounted in a bar, or when using a smaller beverage dispensing system, such as e.g., the DraughtMaster™, the tap handle is typically mounted on a housing of the beverage dispensing system, and typically in front of the keg, so that the tap handle may be easily used by the operator to dispense the beverage.

In many cases, where there is lack of space on the counter at a bar or a café, the beverage dispensing system may have to be placed with the tap handle in a location that is not in front of the keg, but next to it, i.e., with the tap handle to the right or left in respect to the keg. In such cases it may be difficult to use the tap handle in the conventional way to dispense the beverage, since the tap handle in such cases cannot be displaced against the operator. It may sometimes also be desirable to be able to easily operate the beverage dispensing system both from the inside and the outside of a counter or from different sides of a table.

To work around this, the tap handle must be used in an uncomfortable working position to the operator, which may introduce additional strain not only on the operators but also on the tap handle, which over time may lead to malfunction or even a broken tap handle. In addition, operating the tap handles from uncomfortable working positions may cause accidents in the home or professional environment.

There is thus a need for a beverage dispensing system wherein the tap handle for a particular beverage can be operated comfortably and safely from any angle, and which can be reliably used for a long time period, during which beverage containers are replaced when emptied out, without replacing or modifying the operating mechanism thereof.

### SUMMARY

It is therefore an object of the present disclosure to provide an improved beverage dispensing system that enables dispensing of a beverage from multiple angles.

The foregoing and other objects are achieved by the features of the independent claims. Further implementation forms are apparent from the dependent claims, the description and the figures.

According to a first aspect, there is provided a beverage font assembly for dispensing a beverage, comprising a tapping head supported by a beverage font or supportable by a body of a beverage dispensing system. The tapping head comprises a valve configured to control the flow of beverage through the tapping head, and a tap handle being operatively connected to the valve for controlling of the opening and closing thereof. The tap handle is operable between a non-dispensing position where the valve is closed, and a dispensing position where the valve is at least partially open. The tap handle is furthermore configured to be rotatable in the non-dispensing position about a longitudinal axis of the tap handle relative to the tapping head and tiltable from the non-dispensing position in at least two distinct non-opposing directions to assume the dispensing position of the valve.

The beverage font assembly according to this aspect enables the beverage dispensing system to be operated comfortably from multiple angles for dispensing a particular type of beverage, thereby ensuring user safety, as well as avoiding undesirable working positions which could otherwise lead to accidents in the home or professional environment. The tap handle operable in the disclosed manner can also prevent malfunctions or a broken tap handle caused by eccentric or sudden forces which may arise in uncomfortable operating positions.

In a further possible implementation form of the first aspect the tap handle is configured to be rotatable about the longitudinal axis between operating angles wherein the tap handle is arranged to be tiltable; and non-operating angles located in between the operating angles wherein the tap handle is arranged to be non-tiltable.

In an embodiment the operating angles are arranged radially evenly around the longitudinal axis.

In an embodiment the non-operating angles cover ranges between but not including 0° and 180°, more preferably between 45° to 90°.

In an embodiment the operating angles comprise a first operating angle, and a second operating angle arranged at substantially 90° from the first operating angle.

In a further possible implementation form of the first aspect the tap handle is configured to tilt about a pivot axis perpendicular to a longitudinal axis of the tap handle for moving between the non-dispensing position and the dispensing position.

In an embodiment the pivot axis is a needle insert arranged in the tap handle.

In a further possible implementation form of the first aspect the tapping head comprises an actuator mechanism, the actuator mechanism being operably connected to the tap handle and operably connected to the valve, wherein the actuator mechanism is configured to translate movement of the tap handle between the non-dispensing position and the dispensing position into a movement for changing the valve between closed and open configuration.

In a further possible implementation form of the first aspect the actuator mechanism comprises a valve engaging element configured for opening and closing the valve, and a mechanical linkage configured to translate a tilting movement of the tap handle about a pivot axis into translatory movement of the valve engaging element.

In a further possible implementation form of the first aspect the actuator mechanism is connected to the tap handle through a joint, the joint having at least one rotational degree of freedom for allowing rotation of the tap handle about its longitudinal axis relative to the valve engaging element.

In an embodiment the joint is a pivot joint. In another embodiment the joint is a twisting joint.

In a further possible implementation form of the first aspect the tapping head comprises a motion translating means for translating a pivoting movement of the tap handle between the non-dispensing position and the dispensing position into reciprocating motion of the valve engaging element.

In some embodiments the motion translating means is one of a cam, a crank, or an eccentric element such as an eccentric disk or eccentric sphere.

In a further possible implementation form of the first aspect the motion translating means is arranged as part of the tap handle or the actuator mechanism, the motion translating means comprising a pivot pin for pivotably connecting the tap handle and the actuator mechanism around a pivot axis.

In a further possible implementation form of the first aspect the motion translating means comprises a yoke configured to engage the pivot pin.

In some embodiments the tap handle is a replaceable tap handle, wherein an upper part of the yoke comprises a threaded core that corresponds to a threaded recess in the tap handle. This was the tap handle can be easily removed by rotating in a direction according to the threading and a new one inserted as needed by rotation in an opposite direction.

In an alternative implementation form of the first aspect the tap handle comprises a curved surface, and wherein the actuator mechanism comprises a cable secured at one end to the tap handle and extending from the curved surface, the curved surface being arranged to rest on a contact surface of the tapping head with the cable being operably connected to the valve or the valve engaging element.

In possible embodiments the cable is any object that is bendable or flexible but and can exert or transmit force of tension in an axial direction, including but not limited to any one of a string, strap, rope, wire, cord, line, or tether.

In an embodiment the cable is fixedly embedded or cast into the tap handle. In another embodiment the cable is movably embedded in the tap handle. In another embodiment the cable is removably embedded in the tap handle.

In an embodiment the cable extends concentrically with the longitudinal axis of the tap handle.

In an embodiment the tap handle comprises a tap handle bore ending in a tap handle cavity, the tap handle bore having a smaller diameter than the tap handle cavity, wherein the cable is arranged partially within the tap handle bore, the cable being connected at one end to a stopper element arranged rotatably within the tap handle cavity.

In possible embodiments the stopper element is a knot, a ball, disk, or another at least partially cylindrical object, and the cavity is arranged with an at least partially cylindrical, preferably spherical inner surface to allow rotational but not translatory movement of the stopper element therein.

In an embodiment the curved surface is a dome shaped surface. In another embodiment the curved surface is only curved in one direction, for providing operating angles.

In an embodiment the motion translating means, the yoke, or the curved surface of the tap handle comprises a first flat surface configured to abut a corresponding second flat surface of the tapping head, for providing mechanical stability for the tap handle in the non-dispensing position.

In a further possible implementation form of the first aspect the tap handle and the cable are arranged so that translatory movement of the cable caused by tilting the tap handle from the non-dispensing position, in which the tap handle is substantially at a right angle to the contact surface, to a dispensing position results in an opening movement of the valve; and tilting the tap handle from any other angle relative to the contact surface surrounding the opening towards the right angle results in a closing movement of the valve.

In an embodiment the opening movement of the valve is a translatory movement. In another embodiment the opening movement of the valve is a rotational movement.

In a further possible implementation form of the first aspect the beverage font assembly further comprises a resilient element arranged between the tap handle and the valve or between the tap handle and the valve engaging element, configured for urging the tap handle towards the non-dispensing position.

In an embodiment the resilient element is a helical spring. In another embodiment the resilient element is a spring clip. In another embodiment the resilient element is a torsion spring.

In a further possible implementation form of the first aspect the valve comprises a valve body comprising a valve seat, arranged to cooperate with a valve needle, wherein the valve body is adapted to move relative to the valve needle and thereby control opening and closing of the valve.

In an embodiment the valve further comprises a spout for dispensing beverage into a beverage recipient, the valve needle being arranged in the spout, and the valve body of the valve being adapted to move relative to the spout and thereby control opening and closing of the valve.

In a further possible implementation form of the first aspect the valve comprises a retaining element configured for keeping the valve needle in contact with the valve seat and thereby retaining the valve in a closed state when the valve body is not in the tapping head.

According to a second aspect, there is provided a beverage dispensing system comprising beverage font assembly according to any one of the possible implementation forms of the first aspect. The beverage dispensing system is further configured for receiving at least one keg for accommodating a beverage, the at least one keg comprising a closure with a beverage outlet, and at least one dispensing line having a dispensing end and a keg connection end for connecting to the beverage outlet. The valve is connected to the dispensing line at the dispensing end.

In a possible implementation form of the second aspect at least one of the keg, the valve and the dispensing line is exchangeable.

In an embodiment the dispensing line is adapted to be exchanged together with a corresponding keg.

In a further possible implementation form of the second aspect the beverage dispensing system comprises a receptacle for receiving at least part of the at least one keg, and a lid at least partially removable from the receptacle, the receptacle together with the lid defining a sealable enclosure to act as pressure chamber for pressurizing the at least one keg.

In an embodiment the beverage dispensing system comprises a compressor for pressurizing the at least one keg in the sealable enclosure, preferably an air compressor.

In an embodiment the at least one exchangeable keg is a collapsible keg, configured to at least partially collapse upon pressurizing the sealable enclosure.

In an embodiment the dispensing line comprises a dispensing line connector located at the dispensing end, and the valve comprises a valve body comprising a valve seat and a valve connector, the valve connector being adapted to connect the valve body to the dispensing line connector.

In an embodiment the dispensing line connector comprises a circular flange arranged around the dispensing end of the dispensing line, and wherein the dispensing line connector further defines an annular groove, the annular groove being arranged to allow the dispensing line connector to co-operate with a corresponding circumferential recess of the valve connector of the valve body.

In an embodiment the at least one keg is a two-layer keg with a beverage bag inside an outer shell, wherein pressurized fluid from a compressor is applied to an internal space defined between the outer shell and the beverage bag.

In an embodiment the beverage dispensing system comprises a cooling device for cooling the at least one keg and any beverage accommodated therein.

In an embodiment the beverage is beer, a carbonated malt-based beverage, including non-alcoholic beer, or cider.

These and other aspects will be apparent from and the embodiment(s) described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIG. 1 shows a schematic cross-section of a tapping head of a beverage font assembly equipped with a with tap handle in accordance with an embodiment;

FIG. 2 shows a detailed cross-section of a tapping head of a beverage font assembly equipped with a tap handle in accordance with an embodiment;

FIG. 3 shows a detailed cross-section of a portion of the tapping head of a beverage font assembly in accordance with an embodiment;

FIG. 4 shows a 3-dimensional cut-away front view of tapping head of a beverage font assembly in accordance with an embodiment;

FIG. 5 shows a schematic cross-section of a tapping head of a beverage font assembly equipped with a with tap handle in accordance with an alternative embodiment;

FIG. 6 shows a side view of a beverage dispensing system with a beverage font assembly and exchangeable keg in accordance with an embodiment;

FIG. 7 shows a front view of a beverage dispensing system with a beverage font assembly and tap handle in accordance with an embodiment;

FIG. 8 shows a top view of a beverage dispensing system with a beverage font assembly and tap handle in accordance with an embodiment;

FIG. 9 shows a schematic cross-section of a beverage dispensing system with an exchangeable keg and equipped with a tap handle in accordance with another embodiment;

FIG. 10 shows a schematic cross-section of a beverage dispensing systems with an exchangeable keg and equipped with a tap handle in accordance with an alternative embodiment;

FIG. 11 shows a cross-section of a portion of the tapping head of a beverage font assembly in accordance with another embodiment; and

FIGS. 12A to 12C illustrate different examples for implementing a threaded connection between a yoke and a replaceable tap handle in accordance with various embodiments.

### DETAILED DESCRIPTION

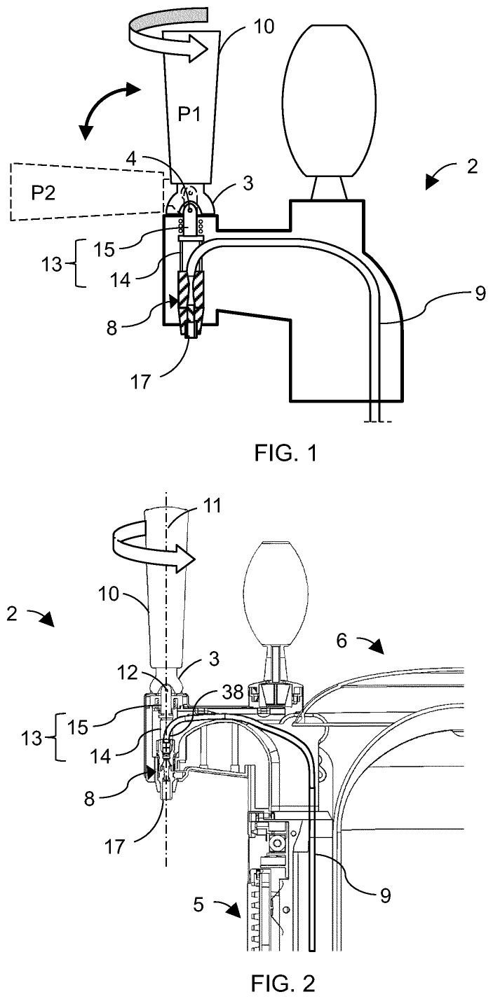

FIG. 1 shows a tapping head 2 of a beverage font assembly 1 for dispensing a beverage according to an embodiment of the present disclosure. The beverage to be dispensed may be for example beer, a carbonated malt-based beverage, including non-alcoholic beer, or cider.

Exemplary beverage font assemblies 1 suitable for use with the tapping head 2 are shown in FIGS. 6 through 10. Accordingly, the tapping head 2 may be supported by a beverage font 5 as shown in e.g. FIG. 6, or may be supportable by a body 6 of a beverage dispensing system as shown in FIG. 10, where instead of using a beverage font the tapping head 2 is directly attached to a housing of a beverage dispensing system that can hold a beverage container.

The tapping head 2 has a front side facing away from the beverage font 5 or body, an opposing rear side, and a valve cavity arranged therein, preferably in the vicinity of the outflow opening of the tapping head 2, and more preferably arranged at front side of the tapping head 2, the valve cavity being adapted to accommodate a valve 8. The valve 8 may be fixed in the tapping head 2, or it may be an exchangeable valve 8 that can be replaced after a period of use.

The tapping head 2 is further provided with a tap handle 10 configured to be operatively connected to the valve 8 for controlling of the opening and closing thereof, and thus ultimately for controlling the flow of beverage from a dispensing line 9. As shown in FIGS. 1, 5, 6, 7, and 10, the tap handle 10 may be operable between a non-dispensing position P1 where the valve 8 is closed, and a dispensing position P2 where the valve 8 is at least partially open to allow flow of beverage from the dispensing line 9 through the tapping head 2. In particular, as will be shown in more detail later, the tap handle 10 is configured to be tiltable from the non-dispensing position P1 in at least two distinct non-opposing directions to assume the dispensing position P2.

In the non-dispensing position P1 the tap handle 10 is substantially vertical, wherein in the dispensing position P2 the tap handle 10 encloses an angle between 0-90° with the longitudinal axis 11 as defined in the vertical position of the tap handle 10.

One solution to achieve this is shown in FIG. 1, wherein the tap handle 10 is configured to be rotatable in the non-dispensing position P1 about a longitudinal axis 11 of the tap handle 10 relative to the tapping head 2, thereby allowing for the tap handle 10 to be tilted into a dispensing position P2 in multiple directions. This enables the beverage dispensing system to be operated comfortably, independent of operator location, thereby ensuring user safety, as well as avoiding undesirable working positions which could otherwise lead to accidents in the home or professional environment. The tap handle 10 operable in the disclosed manner can also prevent malfunctions caused by eccentric or sudden forces which may arise in otherwise uncomfortable operating positions.

The tapping head 2 may further be provided with a tapping display arranged on top for displaying information about the beverage on tap at the respective tapping head.

The tapping head 2 further comprises an actuator mechanism 13 operably connected to the tap handle 10 and also operably connected to the valve 8. This actuator mechanism 13 is configured to translate movement of the tap handle 10 between the non-dispensing position P1 and the dispensing position P2, i.e. a tilting movement, into a movement for changing the valve 8 between closed and open configuration.

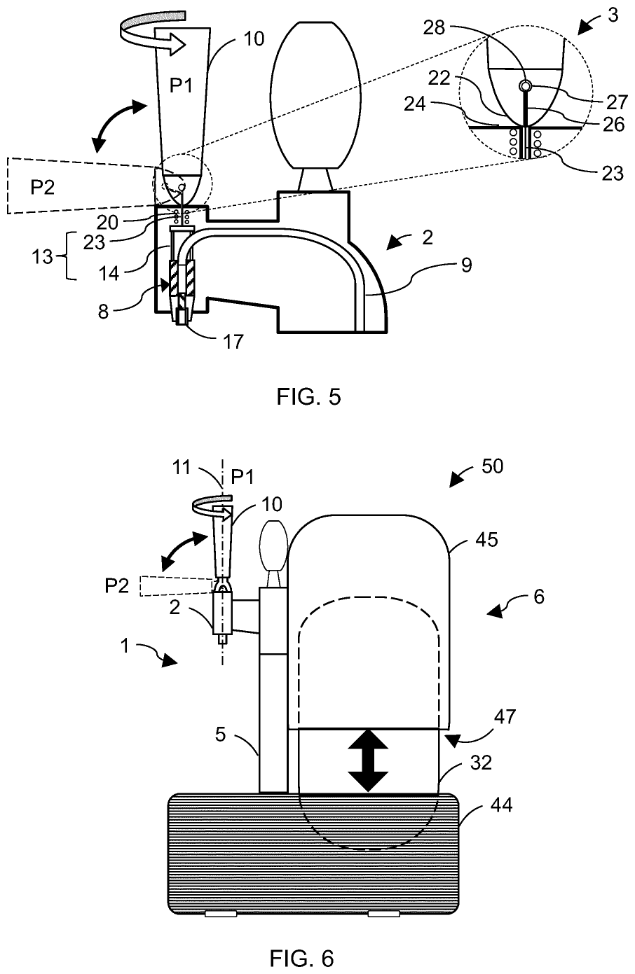

The actuator mechanism 13 may comprise a valve-engaging element 14 configured for opening and closing the valve 8, and a mechanical linkage 15 configured to translate the tilting movement of the tap handle 10 about a pivot axis 12 into translatory movement of the valve engaging element 14, which allows opening or closing the valve 8. The tapping head 2 may also comprise alternative or additional motion translating means 3 for translating a pivoting movement of the tap handle 10 between the non-dispensing position P1 and the dispensing position P2 into reciprocating motion of the valve engaging element 14. In some embodiments the motion translating means 3 is one of a cam (as shown in e.g. FIG. 1, 2), a crank, or an eccentric element such as an eccentric disk or eccentric sphere (as shown in e.g. FIG. 5).

The motion translating means 3 may be arranged either as part of the tap handle 10 or the actuator mechanism 13, depending on the desired configuration.

The valve 8 further may also comprise a spout 17 for dispensing beverage into a beverage recipient, as will be described in detail later.

FIG. 2 shows a detailed cross-section of a tapping head 2 of a beverage font assembly 1 equipped with a tap handle 10 in accordance with an embodiment of the disclosure. In this and following embodiments, structures and features that are the same or similar to corresponding structures and features previously described or shown herein are denoted by the same reference numeral as previously used for simplicity.

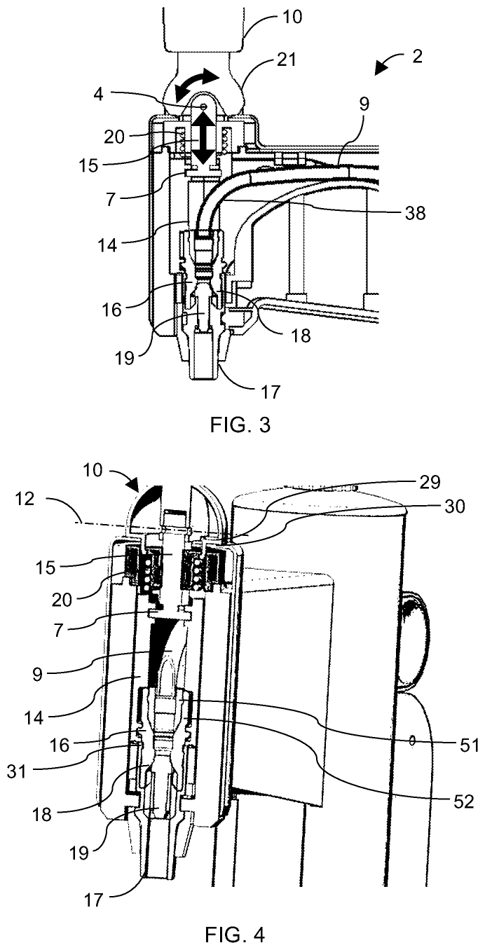

As shown in FIG. 2, the tap handle 10 may be configured to tilt about a pivot axis 12 perpendicular to the longitudinal axis 11 of the tap handle 10 for moving between the non- dispensing position P1 and the dispensing position P2. The pivot axis 12 may be arranged via a needle insert (such as a pivot pin 4 shown in FIG. 3) in the tap handle 10, but any other solutions may be used that are known for a skilled person to provide a suitable pivot axis for such a tap handle. As shown in this embodiment, the tapping head 2 may be arranged on a suitable beverage font 5 that is separate from the main body 6 of the system, and which accommodates at least a portion of the dispensing line 9 attached on a distal keg connection end 39 (not shown) to a beverage container 32 (also not shown), wherein the dispensing end 38 of the dispensing line 9 is arranged in the tapping head 2 in connection with the valve 8, for dispensing beverage through the spout 17 in an open position of the valve 8, as will be described in detail later.

FIG. 3 shows a more close-up, detailed cross-section of the inside of the tapping head 2 in accordance with an embodiment of the disclosure, wherein the motion translating means 3 comprises a pivot pin 4 for pivotably connecting the tap handle 10 and the actuator mechanism 13 around a pivot axis 12, and a yoke 21 configured to engage the pivot pin 4. The actuator mechanism 13 is connected to the tap handle 10 through a joint 7, the joint 7 having at least one rotational degree of freedom for allowing rotation of the tap handle 10 about its longitudinal axis 11 relative to the valve engaging element 14. In an example the joint 7 is a pivot joint. In another example the joint 7 is a twisting joint.

As further shown in FIG. 3 (as well as in other embodiments, even if not explicitly claimed), the beverage font assembly 1 may comprise a resilient element 20 arranged between the tap handle 10 and the valve 8 or the valve engaging element 14 configured for urging the tap handle 10 towards the non-dispensing position P1. In the embodiment illustrated this resilient element 20 is a helical spring arranged around the mechanical linkage 15, abutting the valve engaging element 14 on one end, and an inner wall of the tapping head 2 on another end. In another embodiment the resilient element 20 may be a spring clip, or a torsion spring. Further well-known resilient element examples may also be used as will be evident to a skilled person.

The valve 8 is shown in detail in FIG. 3, wherein as illustrated, the valve 8 may comprise a valve body 16 comprising a valve seat 18, arranged to cooperate with a valve needle 19, the valve body 16 being adapted to move relative to the valve needle 19 and thereby control opening and closing of the valve 8. The valve needle 19 itself may be arranged in the aforementioned spout 17, the valve body 16 in this case being adapted to move relative to the spout 17 and thereby control opening and closing of the valve 8.

The spout 17 may be an integral part of the valve body 16. The spout 17 may extend outside the tapping head 2, such that the spout 17 is the last point of contact for the beverage to be dispensed from the beverage font assembly 1.

FIG. 4 shows a 3-dimensional cut-away model of the tapping head 2 in accordance with an embodiment of the disclosure for illustrating the above-mentioned features from a different angle. As before, structures and features that are the same or similar to corresponding structures and features previously described or shown herein are denoted by the same reference numeral as previously used for simplicity. As shown in FIG. 4, the valve 8 may comprise a retaining element 31 configured for keeping the valve needle 19 in contact with the valve seat 18 and thereby retaining the valve 8 in a closed state when the valve body 16 is not in the tapping head 2, while still allowing the valve 8 to open when a pulling force is applied via the valve engaging element 14. The retaining element 31 is illustrated herein as a latch engaging a corresponding groove arranged in the valve body 16, but other solutions are also possible as will be evident to a skilled person.

In this exemplary embodiment, the motion translating means 3 of the tap handle 10 comprises a first flat surface 29 configured to abut a corresponding second flat surface 30 of the tapping head 2, for providing mechanical stability for the tap handle 10 in the non-dispensing position P1.

As shown in FIG. 4, the dispensing line 9 may comprise a dispensing line connector 51 located at the dispensing end 38 thereof. The valve 8 comprises a valve body 16 as mentioned before, which may further comprise a valve connector 52 adapted to connect the valve body 16 to the dispensing line connector 51. This allows for easy connection and disconnection of the dispensing line 9 from the valve 8 upon replacement.

In an embodiment, as shown in FIG. 4, the dispensing line connector 51 comprises a circular flange arranged around the dispensing end 38 of the dispensing line 9, and the dispensing line connector 51 further defines an annular groove, the annular groove being arranged to allow the dispensing line connector 51 to co-operate with a corresponding circumferential recess of the valve connector 52 of the valve body 16.

As explained above, the actuator mechanism 13 may be connected to the tap handle 10 through a joint 7 having at least one rotational degree of freedom for allowing rotation of the tap handle 10 about its longitudinal axis 11 relative to the valve engaging element 14. This joint 7 may be a circular disk integral with the linkage 15, to be arranged rotatingly in a corresponding circumferential recess of the valve engaging element 14.

FIG. 5 shows a schematic cross-section of a tapping head 2 of a beverage font assembly 1 equipped with a with tap handle 10 according to an alternative embodiment, wherein the tap handle 10 comprises a curved surface 22. The actuator mechanism 13 in this alternative embodiment comprises a cable 23 secured at one end to the tap handle 10 and extending from the curved surface 22.

To achieve this, the tap handle 10 may comprise a tap handle bore 26 ending in a tap handle cavity 27, the tap handle bore 26 having a smaller diameter than the tap handle cavity 27. The cable 23 may be arranged within the tap handle bore 26, connected at one end to a stopper element 28 arranged rotatably within the tap handle cavity 27.

The stopper element 28 may be a knot, a ball, disk, or another at least partially cylindrical object, and the cavity could be arranged with an at least partially cylindrical, preferably spherical inner surface to rotational but not allow translatory movement of the stopper element 28 therein.

In an embodiment the curved surface 22 is a dome shaped surface. In another embodiment the curved surface 22 is only curved in one direction, for providing operating angles A.

The curved surface 22 is arranged to rest on a contact surface 24 of the tapping head 2 with the cable 23 being operably connected to the valve 8 or the valve engaging element 14. This configuration is a relatively simple arrangement that can provide a rotatable tap handle 10 with a few moving parts, and easy and cheap replacement or repairs in case of malfunction.

The cable 23 intended to cover any possible means that is bendable or flexible but and can exert or transmit force of tension in an axial direction, including but not limited to any one of a string, strap, rope, wire, cord, line, or tether. In an embodiment the cable 23 is fixedly embedded or cast into the tap handle 1. In another embodiment the cable 23 is movably embedded in the tap handle 1. In another embodiment the cable 23 is removably embedded in the tap handle 1. As shown in FIG. 5, the cable 23 may extend concentrically with the longitudinal axis 11 of the tap handle 10 for an optimal arrangement.

In operation, similar to the embodiments before, tilting the tap handle 10 from the non-dispensing position P1 to a dispensing position P2 results in a pulling force on the cable 23 due to the arrangement of the curved surface 22 and the contact surface 24. This in turn translates into a translatory (vertical) upward movement of the valve engaging element 14, and consequently, an opening movement of the valve 8.

In particular, as shown in FIG. 5, the tap handle 10 and the cable 23 may be arranged so that translatory movement of the cable 23 caused by tilting the tap handle 10 from the non-dispensing position P1, in which the tap handle 10 is substantially at a right angle to the contact surface 24, to a dispensing position P2 results in an opening movement of the valve 8; and tilting the tap handle 10 from any other angle relative to the contact surface 24 surrounding the opening towards the right angle results in a closing movement of the valve 8.

As with the previously described embodiments, this embodiment may also comprise resilient element 20 arranged between the tap handle 10 and the valve 8 or the valve engaging element 14 configured for urging the tap handle 10 towards the non-dispensing position P1, resulting in a closing movement of the valve 8 once the tap handle 10 is let go. In the embodiment illustrated this resilient element 20 is a helical spring arranged to surround the cable 23, abutting the valve engaging element 14 on one end, and an inner wall of the tapping head 2 on another end. In another embodiment the resilient element 20 may be a spring clip, or a torsion spring. Further well-known resilient element examples may also be used as will be evident to a skilled person.

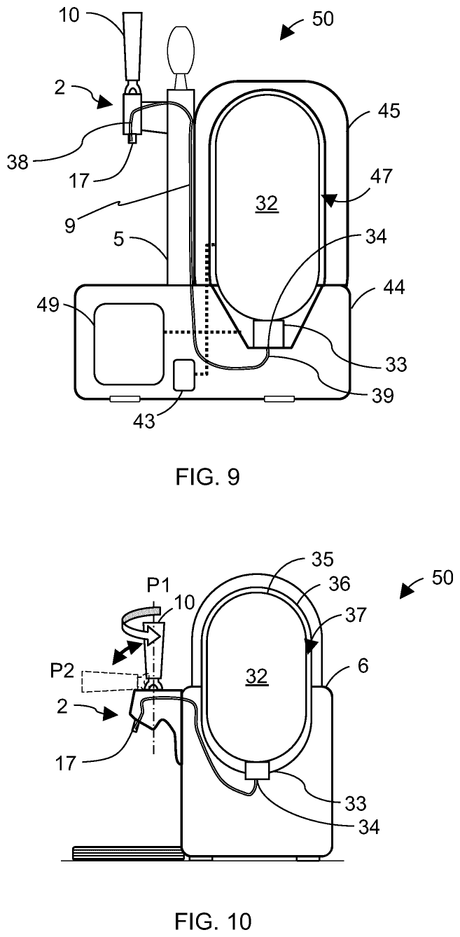

FIG. 6 shows a side view of a beverage dispensing system 50 with a beverage font assembly y 1 in accordance with an embodiment of the disclosure. The beverage dispensing system 50 is configured for receiving at least one keg 32 for accommodating a beverage, the keg 32 comprising a closure 33 with a beverage outlet 34, as illustrated in FIG. 9.

The system 50 comprises at least one dispensing line 9 having a dispensing end 38 and a keg connection end 39 for connecting to the beverage outlet 34, as mentioned before.

The valve 8 of the tapping head 2 is connected to the dispensing line 9 at the dispensing end 38.

Either or all of the keg 32, the valve 8, and the dispensing line 9 may be arranged to be exchangeable, i.e. to be replaced together with the keg 32 when all the beverage is emptied therefrom. In an embodiment the dispensing line 9 is adapted to be exchanged together with a corresponding keg 32.

As further shown in FIG. 6, an upper portion of the body 6 of the beverage dispensing system defined as the lid 45 may be separated at least partially from a lower portion of the body 6 defined as the receptacle 44, thereby further allowing a beverage container, such as an exchangeable keg 32, to be removed from the body 6 and replaced.

When these two parts are connected using a pressure-resistant connection, for example a bayonet mount, a pressure-tight sealable enclosure 47 serving as pressure chamber is established. Herein, the terms “inner chamber” and “pressure chamber” are used interchangeably. The housing of the body 6 is made of pressure proof materials, such as metal or rigid plastic. A bayonet mount refers to a fastening mechanism well-known in the field consisting of a cylindrical male side with one or more radial pins, and a female receptor with matching L-shaped slot and with spring to keep the two parts locked together.

The kegs 32 used for the system may be blow-moulded and of adapted in shape and volume to the volume of the enclosure 47 realized by the receptacle 44 and the lid 45. This allows for mass production of both the kegs 32 and the beverage dispensing systems 50. The pressure housing of the beverage dispensing system 50 and the corresponding kegs 32 may be provided in different sizes.

The keg 32 may be recyclable or disposable after exchanging from an empty to a new keg 32. In an embodiment the keg 32 is a collapsible keg 32, configured to at least partially collapse upon pressurizing the sealable enclosure 47.

The receptacle 44 and the lid 45 are arranged to be separable for inserting and removing kegs 32, as shown in FIG. 6. The separation of the receptacle 44 and the lid 45 may be dependent on tilting the beverage font 5 forward around a hinge arranged at the base of the beverage font 5 (not shown), to release locking means keeping the receptacle 44 and the lid 45 joined together in a pressure resistant connection. The tilting of the beverage font 5 may be further dependent on engaging pressure release means, such as a pressure release button arranged on the front side of the beverage font 5, which triggers pressure release in the pressure chamber, thereby allowing separation of the lid 45 from the receptacle 44 by equalizing pressure within the pressure-tight sealable enclosure 47 formed by the receptacle 44 and the lid 45 with the outside environment of the beverage dispensing system. In some embodiments, the receptacle 44 and the lid 45 are only partially separable such that the lid 45 remains connected to the body 6, e.g. through a hinge. The sealable enclosure 47 may define a volume between 2 and 100 litres, preferably between 5 and 50 litres, more preferably between 10 and 25 litres. The above volumes constitute typical volumes of a pressure chamber. The beverage containers have a corresponding size, being slightly smaller for a tight fit inside the pressure chamber.

According to a further embodiment, the beverage dispensing system 50 may comprise additional housing parts acting as a replacement of the lid 45, having an additional volume and being connectable to the receptacle 44 for establishing the sealable enclosure 47 serving as pressure chamber. In this way, the same base body 6 may be used together with different further housing parts of different size, so that the beverage dispensing system may be modified to a specific beverage container size, e.g. 5 liters, 10 liters or 20 liters. The additional housing parts may be exchangeable by the user, e.g. by providing a screw mount.

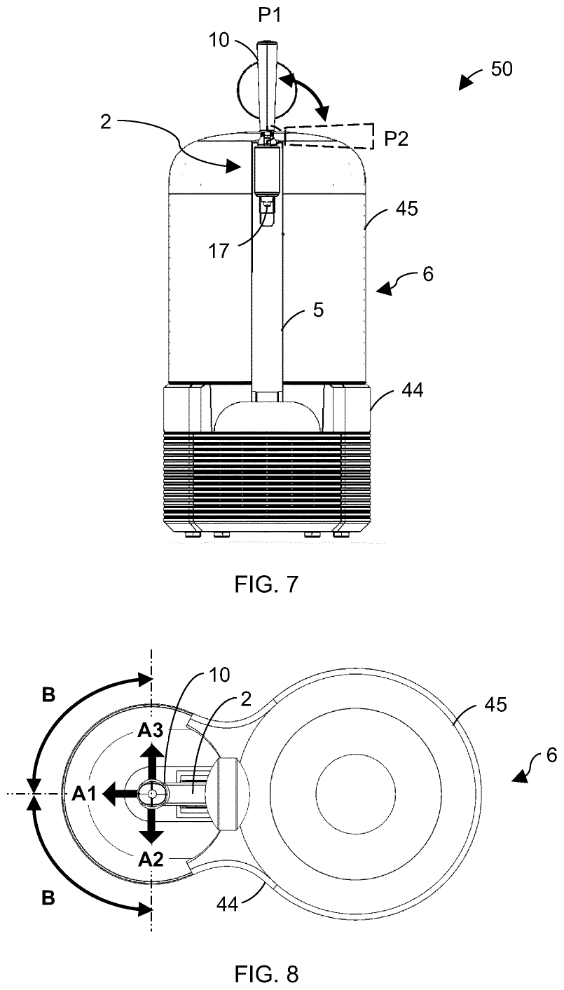

FIG. 7 shows a front view of a beverage dispensing system 50 with a beverage font assembly 1 and tap handle 10 in accordance with an embodiment of the disclosure. This embodiment corresponds to the embodiment of FIG. 6 and works in a similar fashion as described before and illustrated therein for changing between a non-dispensing position P1 and a dispensing position P2. In this embodiment, like before, structures and features that are the same or similar to corresponding structures and features previously described or shown herein are denoted by the same reference numeral as previously used for simplicity.

As shown in FIG. 7, the tap handle 10 can be tilted from a non-dispensing position P1 to a dispensing position P2 in a plane that is outside of the plane of symmetry of the beverage dispensing system 50, i.e. the tap handle 10 can be tilted to the side for opening the valve 8 and dispensing beverage through the spout 17. Further details describing the operating angles A of the tap handle 10 are disclosed below with respect to FIG. 8.

FIG. 8 shows a top view of a beverage dispensing system with a beverage font assembly 1 and tap handle 10 in accordance with an embodiment, wherein the tap handle 10 is configured to be rotatable about the longitudinal axis 11 between operating angles A and non-operating angles B. In the operating angles A the tap handle 10 is tiltable, i.e. its position can be changed from a non-dispensing position P1 into a dispensing position P2. In the non-operating angles B the tap handle 10 is however arranged to be non-tiltable, i.e. it is locked in the non-dispensing position P1. As the figure shows, there are at least two non-opposing operating angles A (i.e. enclosing an angle larger than 0° but smaller than 180°), and the non-operating angles B cover the ranges in between these operating angles A.

In an embodiment the operating angles comprise a first operating angle A1, and a second operating angle A2 arranged at substantially 90° from the first operating angle A1. In a further possible embodiment the operating angles comprise a third operating angle A3, also arranged at substantially 90° from the first operating angle A1 but in an opposite direction thereof. The operating angles A may also be arranged radially evenly around the longitudinal axis 11.

The non-operating angles B cover ranges between but not including 0° and 180°, more preferably between 45° to 90°. Such arrangements ensure that the tap handle 10 is only operable is predefined angles, which helps to avoid accidental tilting into a dispensing position P2 and thereby unintended dispensing of a beverage.

In a possible example the tapping head 2 may comprise a second resilient element (not shown) such as a spring, and a washer with cuts or grooves arranged corresponding to the operating angles A1, A2 and/or A3, arranged between the tap handle 10 and the actuator mechanism 13. This washer would only allow the tap handle 10 to be tilted when the tap handle 10 is aligned with the cuts or grooves arranged in the washer, otherwise the tap handle 10 could not be tilted, thereby enabling the beverage to only be dispensed in the operating angles A.

FIG. 9 shows a schematic cross-section of a beverage dispensing system with an exchangeable keg and equipped with a tap handle in accordance with another embodiment. The embodiment shown in FIG. 9 corresponds to the embodiments of FIGS. 6-8 and works in a similar fashion as described before and illustrated therein for changing between a non-dispensing position P1 and a dispensing position P2. In this embodiment, like before, structures and features that are the same or similar to corresponding structures and features previously described or shown herein are denoted by the same reference numeral as previously used for simplicity.

The system may comprise an exchangeable keg 32 for accommodating a beverage, the keg 32 comprising a closure 33 with a beverage outlet 34. The dispensing line 9 extends from this beverage outlet 34, e.g. along a rear side of the beverage font 5, to the the tapping head 2. As shown in FIGS. 3 and 4 in more detail, the exchangeable dispensing line 9 has a dispensing end 38 for connecting to an exchangeable valve 8.

The body 6 of the beverage dispensing system comprises a receptacle 44 and a lid 45. The receptacle 44 is designed and shaped for receiving at least a portion of the keg 32, preferably a smaller portion of the keg 32 comprising the closure 33 in an upside down position; and the lid 45 is arranged to cover at least a portion, preferably a larger portion of the keg 32 when the at least one keg 32 is received in the receptacle 44.

A keg closure cavity may be arranged at the bottom of the receptacle 44, designed to accommodate at least a portion of the keg 32. The keg closure cavity may comprise a coupler adapted for receiving at least one type of closure 33 of an exchangeable keg 32 and for allowing passage of the exchangeable dispensing line 9. The coupler thus forms an access point for accessing the beverage outlet 34 of a beverage container, such as an exchangeable keg 32, and the beverage accommodated therein. The coupler may be interchangeable in order to adapt the beverage dispensing system to an exchangeable dispensing line 9 or a fixed dispensing line, respectively. The closure 33 of a suitable keg 32 is insertable into the keg closure cavity and may be fixated to the coupler in a sealed and pressure-tight fit. Preferably, the closure 33 is fixated to the coupler e.g. by a screw fit, bayonet fit or the like.

The keg connection end 39 of the exchangeable dispensing line 9 may be arranged to sealingly fit into the through-hole of the coupler and serve as a sealing interphase and connect with the beverage outlet 34 of the keg 32.

The dispensing line 9, when arranged as an exchangeable part, can be inserted and guided through the through-hole of the coupler before mounting the keg 32 in the receptacle 44, such that the keg connection end 39 of the dispensing line 9 abuts and sits sealingly in the coupler, positioned for connecting to the beverage outlet 34 upon mounting the keg 32 in the receptacle 44. The dispensing line 9 may also be provided with the keg 32, either as a separate item and attached to the closure 33 shortly before use, e.g. using a click connection mechanism, or in an alternative embodiment the dispensing line may also be permanently attached to the closure 33 of the keg.

The coupler may be installed permanently in the keg closure cavity, such that the beverage dispensing system 50 is permanently made to be used with the specific type of keg 32. Alternatively, the user may be provided with different types of couplers allowing the user to change coupler type on site in order to be able to modify the beverage dispensing system to be used with different types of kegs 32 according to consumption of a particular beverage.

A pressure inlet may be adapted for receiving a pressure medium and transport the pressure medium to an interspace between the outer wall of the keg 32 and the inner wall of the sealable enclosure 47. The interspace is typically made as small as possible, e.g. a few millimeters of width, in order to allow a tight fit between a beverage container and a pressure chamber. The pressure inlet may form part of e.g. the receptacle 44, the lid 45 or the coupler 41, and may optionally include a one-way valve and/or overpressure valve.

The pressure medium is typically air; however, any fluid would be feasible, such as CO2, N2, water etc.

As further shown in FIG. 9, the beverage dispensing system may also comprise a compressor 43 and/or a gas cylinder selectively connectable to the pressure inlet for providing the pressure medium to the interspace. In order to make the system more modular, the pressure inlet and the beverage dispensing systems may be compatible with different pressurization units. A compressor 43 may be used when access to either mains power or battery power is available to power the compressor 43 allowing it to pressurize the pressure chamber by taking atmospheric air from the outside, pressurize it and inject the pressurized air into the interspace of the pressure chamber. A gas cylinder may be used where no mains power is available and/or batteries are considered an inconvenient choice. The gas cylinder is pre-loaded with a pressurized gas, e.g. air, nitrogen, carbon dioxide or the like.

The pressure chamber may be thermally insulated. The thermal insulation may be used in conjunction with a cooling device 49 for cooling of the at least one keg 32 and any beverage accommodated therein, or alternatively, the cooling device 49 may be dispensed with and instead a thermal insulation is used in conjunction with pre-chilled beverage containers in order to save weight in e.g. carry-on appliances.

FIG. 10 shows a beverage font assembly 1 in accordance with an alternative embodiment of the present disclosure, wherein the tapping head 2 is directly mounted on a body 6 of a beverage dispensing system.

The tap handle 10 of this embodiment works in a similar fashion as described before and illustrated in FIGS. 1-4 or FIG. 5, with the difference that the beverage font assembly 1 does not include a beverage font 5, instead the tapping head 2 is supported directly on a body 6 adapted to accommodate an exchangeable keg 32. The exchangeable keg 32 can be the same for all the disclosed embodiments, comprising a closure 33 with a beverage outlet 34. An (exchangeable) dispensing line 9 may extend from the beverage outlet 34, through the body 6, to the tapping head 2.

In an alternative embodiment, as illustrated in FIG. 10, the keg 32 may comprise a beverage filled bag 35 inside an outer shell 36, wherein pressurized fluid from a compressor 43 may be applied to the space 37 between the outer shell 36 and the bag 35 for pressurizing the at least one keg 32 for initiating beverage flow through the exchangeable dispensing line 9 to the tapping head 2.

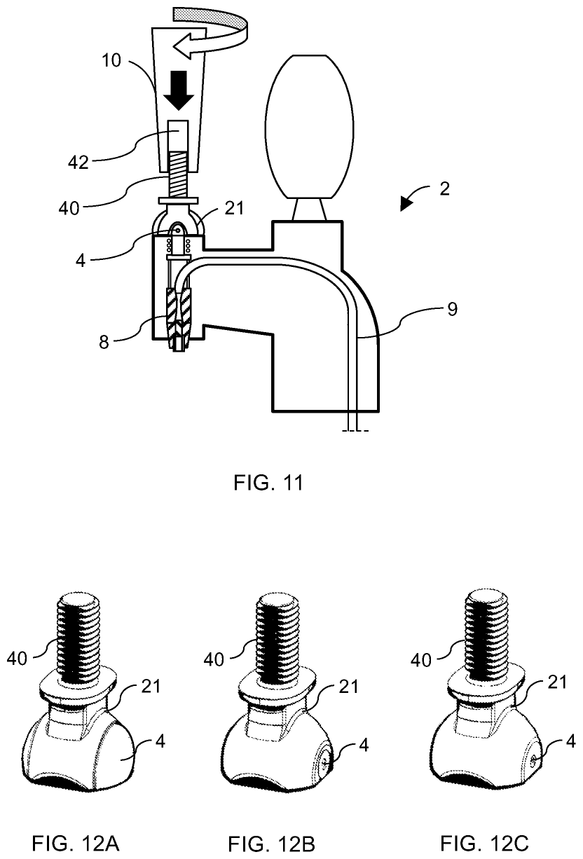

FIG. 11 shows a detailed cross-section of the inside of the tapping head 2 with a possible solution for an easily replaceable tap handle 10 that can be implemented in any previously discussed embodiments. Such a replaceable tap handle 10 can be advantageous if combined with the rotatable aspect as discussed before, since alternative tap handles 10 can be applied depending on the applied tilting directions corresponding to installation circumstances.

Herein the motion translating means 3 comprises a pivot pin 4 for pivotably connecting the replaceable tap handle 10 and the actuator mechanism 13 around a pivot axis 12, and a yoke 21 configured to engage the pivot pin 4.

The upper part of the yoke 21 comprises a threaded core 40 that corresponds to a threaded recess 42 in the tap handle 10. This way the tap handle 10 can be easily removed by rotating in a direction according to the threading (the illustrated direction being only an example) and a new one inserted as needed by rotation in an opposite direction.

FIGS. 12A to 12C illustrate different alternative examples for implementing a threaded connection between a yoke 21 and a replaceable tap handle 10, with the main difference being how the tilting around the pivot axis 12 is enabled.

As shown in FIG. 12A, the pivot pin 4 can be implemented in a way that is hidden behind a cover over the yoke 21, where the pivot pin 4 can be implemented as a large cylindrical cross-section element fitting in the arch of the yoke.

As shown in FIG. 12B, the pivot pin 4 can also be implemented in a way that is only partially hidden behind a cover, with the ends of the pivot pin 4 of a smaller cylindrical cross-section being visible and the pivot pin 4 thus adjustable manually for different circumstances according to the required force needed for tilting and tapping.

As shown in FIG. 12C, the pivot pin 4 can also be implemented in a way that is only partially hidden behind a cover, with the ends of the pivot pin 4 of an even smaller cylindrical cross-section being visible and potentially also adjustable manually.

The beverage dispensing system 50 of any of the described embodiments may further comprise a first electric power unit including a mains supply and a second power unit including a battery supply, and, optionally, a third power supply including a solar power supply. In order to further enhance the modularity of the system, it may be compatible with different power supplies. For fixed indoor installations, a mains power supply, e.g. 115V or 230V AC household supply, is preferred since it offers essentially unlimited power to the system for powering both cooling and pressurization units as well as other features such as lighting etc. Batteries may advantageously be used in mobile appliances. The batteries may e.g. be rechargeable by the use of a mains supply and a power converter. Solar power may be used for directly powering the beverage dispensing system, however, due to the limited output of solar cells when no direct sunlight is available it is mostly considered an auxiliary power unit to be used in conjunction with rechargeable batteries.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims indicate does not that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure. As used in the description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

1. A beverage font assembly for dispensing a beverage, the beverage font assembly comprising:
a tapping head supported by a beverage font or supportable by a body of a beverage dispensing system, the tapping head comprising a valve configured to control the flow of beverage through the tapping head, and
a tap handle being operatively connected to the valve for controlling of the opening and closing thereof, the tap handle operable between a non-dispensing position where the valve is closed, and a dispensing position where the valve is at least partially open,
wherein the tap handle is configured to be rotatable in the non-dispensing position about a longitudinal axis of the tap handle relative to the tapping head,
wherein the tap handle is configured to be tiltable from the non-dispensing position in at least two distinct non-opposing directions to assume the dispensing position of the valve.

2. The beverage font assembly according to claim 1, wherein the tap handle is configured to be rotatable about the longitudinal axis between operating angles wherein the tap handle is arranged to be tiltable; and non-operating angles located in between the operating angles wherein the tap handle is arranged to be non-tiltable.

3. The beverage font assembly according to claim 1, wherein the tap handle is configured to tilt about a pivot axis perpendicular to a longitudinal axis of the tap handle for moving between the non-dispensing position and the dispensing position.

4. The beverage font assembly according to claim 1, wherein the tapping head comprises an actuator mechanism, the actuator mechanism being operably connected to the tap handle and operably connected to the valve, wherein the actuator mechanism is configured to translate movement of the tap handle between the non-dispensing position and the dispensing position into a movement for changing the valve between closed and open configuration.

5. The beverage font assembly according to claim 4, wherein the actuator mechanism comprises a valve engaging element configured for opening and closing the valve, and a mechanical linkage configured to translate a tilting movement of the tap handle about a pivot axis into translatory movement of the valve engaging element.

6. The beverage font assembly according claim 5, wherein the actuator mechanism is connected to the tap handle through a joint, the joint having at least one rotational degree of freedom for allowing rotation of the tap handle about its longitudinal axis relative to the valve engaging element.

7. The beverage font assembly according to claim 5, wherein the tapping head comprises a motion translating means for translating a pivoting movement of the tap handle between the non-dispensing position and the dispensing position into reciprocating motion of the valve engaging element.

8. The beverage font assembly according to claim 7, wherein the motion translating means is arranged as part of the tap handle or the actuator mechanism, the motion translating means comprising a pivot pin for pivotably connecting the tap handle and the actuator mechanism around a pivot axis.

9. The beverage font assembly according to claim 8, wherein the motion translating means comprises a yoke configured to engage the pivot pin.

10. The beverage font assembly according to claim 7, wherein the tap handle comprises a threaded recess, and wherein the motion translating means comprises a threaded core that corresponds to the threaded recess so that the tap handle is easily replaceable on the tapping head.

11. The beverage font assembly according to claim 4, wherein the tap handle comprises a curved surface, and wherein the actuator mechanism comprises a cable secured at one end to the tap handle and extending from the curved surface, the curved surface being arranged to rest on a contact surface of the tapping head with the cable being operably connected to the valve or the valve engaging element.

12. The beverage font assembly according to claim 11, wherein the tap handle and the cable are arranged so that translatory movement of the cable caused by tilting the tap handle from the non-dispensing position, in which the tap handle is substantially at a right angle to the contact surface, to a dispensing position results in an opening movement of the valve; and tilting the tap handle from any other angle relative to the contact surface surrounding the opening towards the right angle results in a closing movement of the valve.

13. The beverage font assembly according to claim 5, further comprising a resilient element arranged between the tap handle and either the valve or the valve engaging element configured for urging the tap handle towards the non-dispensing position.

14. The beverage font assembly according to claim 1, wherein the valve comprises a valve body comprising a valve seat, arranged to cooperate with a valve needle, wherein the valve body is adapted to move relative to the valve needle and thereby control opening and closing of the valve.

15. The beverage font assembly according to claim 14, wherein the valve comprises a retaining element configured for keeping the valve needle in contact with the valve seat and thereby retaining the valve in a closed state when the valve body is not in the tapping head.

16. A beverage dispensing system comprising a beverage font assembly according to claim 1, the beverage dispensing system comprising:
at least one keg for accommodating a beverage, the at least one keg comprising a closure with a beverage outlet, and at least one dispensing line having a dispensing end and a keg connection end for connecting to the beverage outlet, the valve being connected to the dispensing line at the dispensing end.

17. The beverage dispensing system according to claim 16, wherein at least one of the keg, the valve and the dispensing line is exchangeable.

18. The beverage dispensing system according to claim 16, wherein the beverage dispensing system comprises a receptacle for receiving at least part of the at least one keg, and a lid at least partially removable from the receptacle, the receptacle together with the lid defining a sealable enclosure to act as pressure chamber for pressurizing the at least one keg.

19. The beverage dispensing system according to claim 16, wherein the at least one keg comprises a beverage filled bag inside an outer shell, wherein pressurized fluid from a compressor is configured to be applied to a space between the outer shell and the bag for pressurizing the at least one keg (32) for initiating beverage flow through the exchangeable dispensing line to the tapping head (2).
